(19) United States
(12) Patent Application Publication
(10) Pub. No.: US 2012/0166412 A1
(43) Pub. Date: Jun. 28, 2012

(54) SUPER-CLUSTERING FOR EFFICIENT INFORMATION EXTRACTION

(75) Inventors: Srinivasan Hanumantha Rao SENGAMEDU, Bangalore (IN); Rejeev Rastogi, Bangalore (IN); Charu Tiwari, Bhopal (IN)

(73) Assignee: Yahoo! Inc, Sunnyvale, CA (US)

(21) Appl. No.: 12/975,391

(22) Filed: Dec. 22, 2010

(51) Int. Cl. G06F 17/30

(52) U.S. Cl. 707/709; 707/E17.108

(57) ABSTRACT

A set of clusters associated with a plurality of web pages is received. A first data set and a second data set are generated by applying a first rule and the second rule, respectively, to web pages of a first cluster of the set of clusters. The second rule is substituted for the first rule responsive to having an acceptable extraction accuracy when applied to the first cluster. The extraction accuracy of the second rule is determined by comparing attributes of the second data set to attributes of the first data set.

### FIELD OF THE INVENTION

Embodiments of the present invention relate generally to the field of data extraction using a computing system, and more specifically, to reducing a number of rules used for data extraction.

### BACKGROUND

Some businesses, such as research industries, make use of information extracted from the Internet. Data extraction on the web is a technique for crawling pages from web sites, clustering the pages, and writing wrapper rules for each cluster to extract information from the pages.

Typically, the clustering is done based on the structure of the pages to extract the information with high precision. In doing so, homogeneous web pages that have the same structures are clustered together, while heterogeneous web pages having different structures are assigned to different clusters.

Further, when a new page is crawled from a web site, its structure is matched with the structure of the stored clusters, and the rule corresponding to the closest cluster, among the stored clusters, may be applied to extract the information from the new page. As the number of the stored clusters increases, the time to match the structure of the new page with the structure of each of the stored pages also increases, and, subsequently, the processing time to extract the relevant information also increases. This makes the task of information extraction tedious and inefficient.

In light of the foregoing discussion, there is a need for a method and a system to provide additional efficiency in extracting the relevant information.

### SUMMARY

To address shortcomings of the prior art, methods, computer program products, and systems are provided for improved data extraction.

In one embodiment, each rule is applied against each cluster, and evaluated for accuracy. Accuracy can be determined by comparing extraction results of a cluster against a baseline data set generated by a rule originally assigned to the cluster. When a cluster can be extracted using more than one rule, with sufficient accuracy, a rule reduction is possible by combining the clusters to form a super cluster. Data is then extracted from the super cluster using a common rule.

In an alternative embodiment, the method includes receiving a set of clusters associated with a plurality of crawled web pages. Each cluster may be defined by a subset of the plurality of web pages having a common page structure for data extraction. The method further includes extracting a first data set, corresponding to the first cluster, by applying a first rule to web pages of a first cluster of the set of clusters. Further, the method includes applying a second rule, corresponding to a second cluster, to the web pages of the first cluster to extract a second data set. The method further includes determining an extraction accuracy of the second rule by comparing attributes of the second data set to attributes of the first data set. Further, the second rule is set for data extraction from the web pages associated with the first cluster responsive to the extraction accuracy meeting a predetermined threshold value.

In another embodiment, a system includes a clustering module to receive a set of clusters associated with a plurality of crawled web pages, each cluster defined by a subset of the plurality of web pages having a common page structure for data extraction. Further, the system includes a data extraction module communicably coupled to the clustering module and a rule selection module communicably coupled with the data extraction module. The data extraction module is configured to extract a first data set by applying a first rule to web pages of a first cluster of the set of clusters. The data extraction module is further configured to apply a second rule to the web pages of the first cluster to extract a second data set. The first rule is corresponding to the first cluster and the second rule is corresponding to a second cluster of the set of clusters. Further, the rule selection module is configured to determine an extraction accuracy of the second rule by comparing attributes of the second data set to attributes of the first data set. The rule selection module is further configured to set the second rule for data extraction from the web pages associated with the first cluster responsive to the extraction accuracy meeting a predetermined threshold value.

In yet another embodiment, a computer program product includes a computer usable medium having a computer readable program code embodied therein for data extraction. The computer readable program code, when executed, performs a method. The method includes receiving a set of clusters associated with a plurality of crawled web pages, each cluster defined by a subset of the plurality of web pages having a common page structure for data extraction. Further, the computer program code extracts a first data set by applying a first rule to web pages of a first cluster of the set of clusters. Further a second data set is extracted by applying a second rule to the web pages of the first cluster. The first rule corresponding to the first cluster and the second rule corresponding to a second cluster of the set of clusters. Furthermore, the computer program product performs determining an extraction accuracy of the second rule by comparing attributes of the second data set to attributes of the first data set. The computer program product further performs setting the second rule for data extraction from the web pages associated with the first cluster responsive to the extraction accuracy meeting a predetermined threshold value.

Advantageously, data is extracted in a faster, less processor-intense manner.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for providing aggregated data, in accordance with an embodiment.

FIG. 2 is a flow chart illustrating a method for data extraction using super clustering, in accordance with an embodiment.

FIG. 3 is a flow chart illustrating a method for generating super clusters, in accordance with an embodiment.

FIG. 4 is a flow chart illustrating a method for removing duplicates of approved rules, in accordance with an embodiment.

FIGS. 5A-B are schematic diagrams illustrating web pages of different clusters that can be combined for the purpose of data extraction, in accordance with an embodiment.

FIGS. 6A-B are schematic diagrams illustrating data extracted from the web pages of different clusters using a common rule, in accordance with an embodiment.

FIG. 7 is a block diagram of a system for data extraction using super clustering, in accordance with an embodiment.

FIG. 8 is a block diagram of a data extraction server, in accordance with an embodiment.

FIG. 9 is a block diagram of a data extraction module, in accordance with an embodiment.

### DETAILED DESCRIPTION

The present disclosure describes a method, system and computer program product for data extraction from, for example, a plurality of web pages. The following detailed description is intended to provide example implementations to one of ordinary skill in the art, and is not intended to limit the invention to the explicit disclosure, as one or ordinary skill in the art will understand that variations can be substituted that are within the scope of the invention as described.

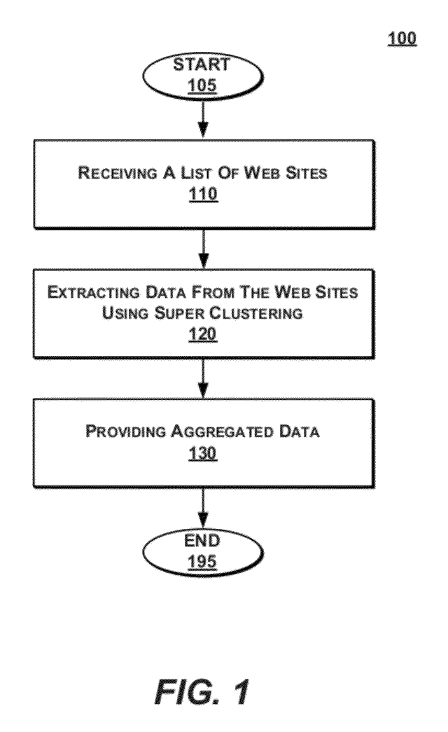

FIG. 1 is a flow chart illustrating a method 100 for providing aggregated data, in accordance with an embodiment.

At step 110, a list of web sites is received. An administrator or database operator configures a data extractor with URLs (Universal Resource Locators) used to identify web sites for extraction. The web sites can be merchant web sites, scientific data web sites, or any other type of web site including formatted data. In one embodiment, web sites are selected according to subject matter. For example, the web sites can each relate to books for sale. The web site URL can be provided simply at a root level (i.e., www.website.com) without specifying specific web pages within the web site (i.e., www.website.com/books/divinci-code.html).

The web pages may be associated either with a common web site (e.g., Amazon.com or Ebay.com) or a common subject matter (e.g., video equipment, books, or sports statistics). The web pages can be composed using a mark-up coding language such as HTML, XML or the like. The web pages can also be formatted according to dynamic coding language such as PHP and include dynamic components such as Java or Flash. Moreover, the web pages can be standard web pages or modified web pages for mobile devices.

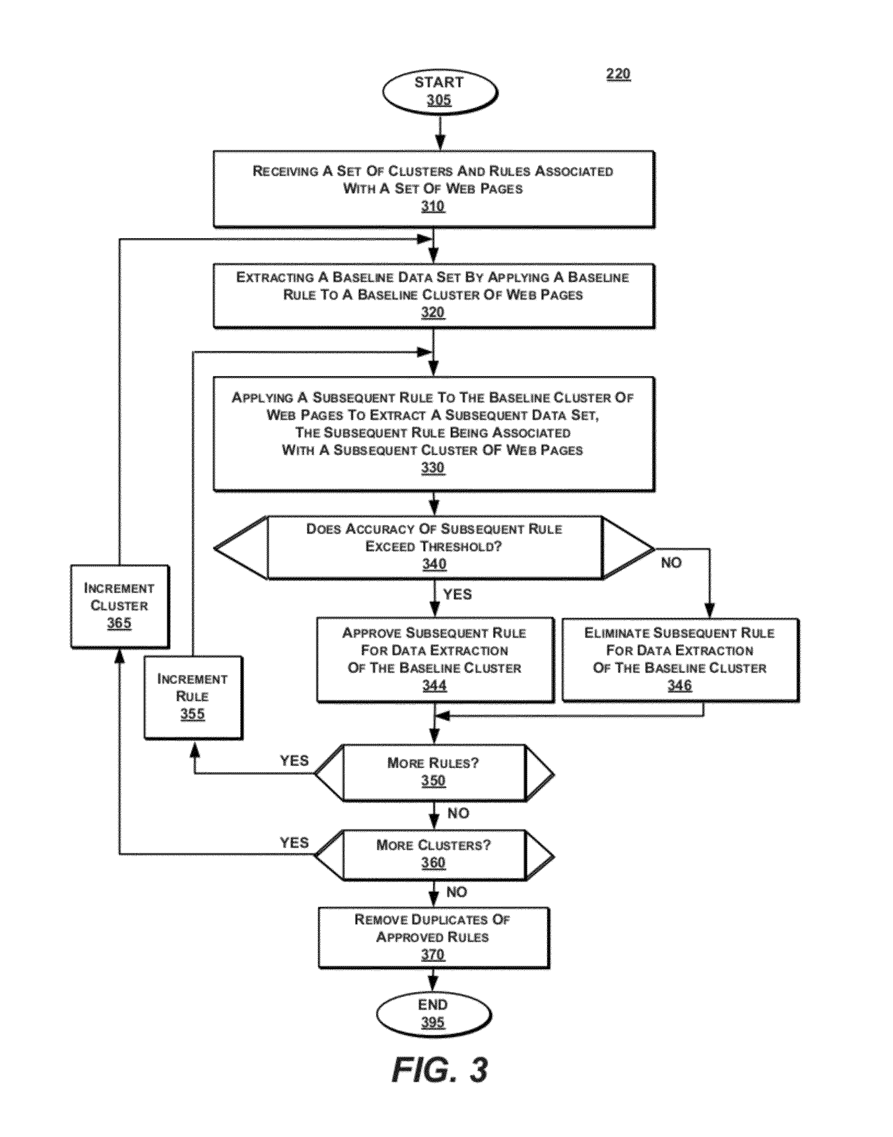

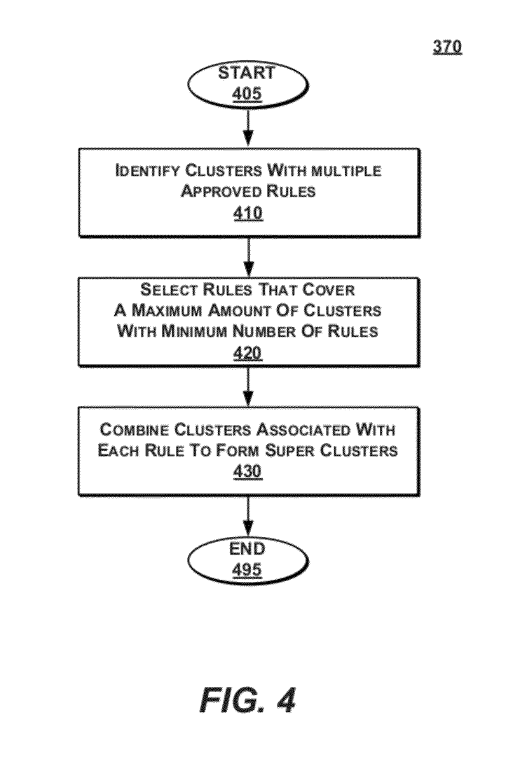

At step 120, data is extracted from web sites using super clustering. In one embodiment, rules are reduced by applying rules from other clusters to a single cluster. When other rules qualify for use on the single cluster, rule reductions are possible, as described in greater detail with respect to FIG. 3, to be removed as duplicates. In another embodiment, rules are reduced by applying a single rule to other clusters. When the single rule qualifies for use on the other clusters, rule reductions are possible, as described in greater detail with respect to FIG. 4, to be removed as duplicates.

The plurality of web pages may be received as a set of clusters. Each cluster may be defined by a subset of the plurality of web pages that has a common or homogeneous page structure. A different cluster is generated for each subset of the plurality of web pages that have relatively different or heterogeneous page structure. The page structure, in one example, comprises a type and order of header fields in HTML code. Further, each cluster has an associated rule that may be utilized to extract information based on the common page structure. When a new web page is received, the data may be extracted from the new web page by applying a particular rule corresponding to the web page. As each cluster has a particular rule associated therewith, the new web page may be matched with each of the available clusters by utilizing the corresponding rule, to determine an appropriate cluster having common page structure. The number of rules is reduced to minimize the matching time of the web page with all of available clusters to determine the appropriate rule for data extraction from the web page.

A rule may be configured manually or automatically to extract information from the web pages of the corresponding cluster. Accordingly, a set of ten clusters is initially configured with a set of ten rules. In one example, a rule composition uses HTML headers to navigate a web page for location and retrieval of relevant data. Thus, each of the ten clusters is structured with a unique combination of HTML headers. A new web page is compared against the ten clusters to determine the best fit. After combining rules of different clusters, the new web page is compared against fewer clusters (e.g., six or eight clusters) to determine the best fit. By reducing the number of available rules (and available clusters), the processing time for the new web page may be reduced, and thus relevant information may be extracted more efficiently. On larger scales, even more efficiency is realized.

At step 130, aggregated data is provided. After populating a database with extracted data, the database can be searched responsive to queries. For example, a user searching for DVDs can be presented a table of DVD information containing data pulled from different web pages.

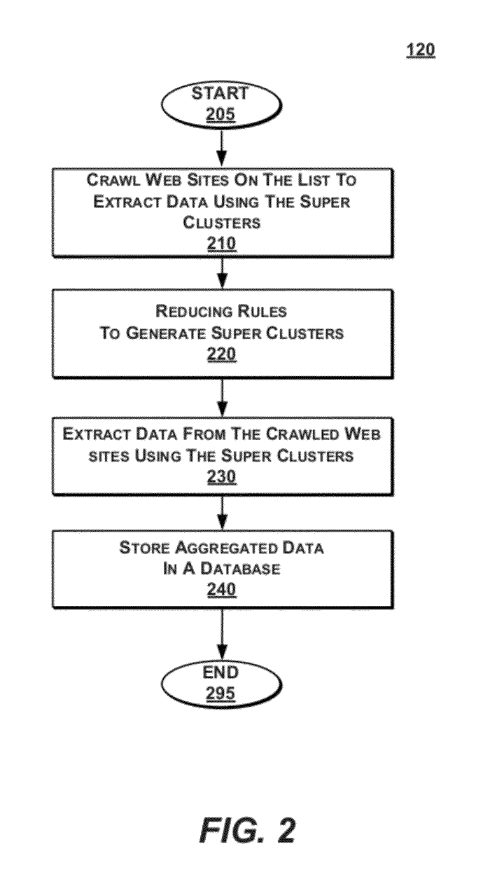

FIG. 2 is a flow chart illustrating a method 200 for data extraction using super clustering, in accordance with a first embodiment.

At step 210, web sites on a list are crawled to extract data. The crawler sends requests for web pages using a protocol such as HTTP. The pages can be requested in a systematic manner to make sure that all pages are crawled.

At step 220, rules are reduced to generate super clusters (or super rules). In one embodiment, each rule is applied against each cluster, and evaluated for accuracy. Accuracy can be determined by comparing extraction results of a cluster against a baseline data set generated by a rule originally assigned to the cluster. When multiple rules qualify for use on a single cluster, rule reductions are possible to be removed as duplicates, as is described in greater detail with respect to FIG. 3.

At step 230, data is extracted from crawled web sites using the super clusters. The reduced rule set leads to faster processing.

At step 240, aggregated data is stored. Data can be formatted as needed. For example, books from different web sites can be aggregated. An interface to a database or storage network determines where to store the formatted data. Various implementations can further replicate or migrate stored data as needed. The data can be stored to be accessible to the public or just to subscribers. FIG. 3 is a flow chart illustrating an exemplary method 210 for generating super clusters, in accordance with an embodiment.

At 310, a set of clusters and rules associated with a set of web pages is received. Each cluster may be defined by a subset of the plurality of web pages having a common page structure for data extraction. Further, the page structure of web pages associated with one cluster may be different from the page structure of the web pages associated with another cluster. Each received cluster may be generated by using a basic clustering technique such as shingling. In one embodiment, a web page structure is defined by HTML headers appearing in a particular order.

At 320, a baseline data set is extracted by applying a baseline rule to a baseline cluster of web pages. The baseline rule may be written specifically for the cluster to extract information therefrom. The first data set may include a first set of plurality of attributes, such as data types (e.g., title, price, quantity, shipping time, etc.) and data values (e.g., numerical values, TRUE or FALSE values, yes or no values, etc.), corresponding to the web pages of the first cluster, extracted by applying the first rule. The first data set, produced from a custom rule composed for the corresponding structure of web pages in the first cluster, serves as a baseline standard for matching data sets produced by corresponding rules.

At 330, a subsequent rule is applied to a baseline cluster of web pages to extract a subsequent data set. The subsequent rule is associated with a subsequent cluster of web pages. The subsequent rule initially corresponds to a second rule from a second cluster, and is incremented during each loop of the process (step 355). A subsequent data set may include a second set of plurality of attributes, such as data types and data values, corresponding to the web pages of the first cluster, extracted by applying the subsequent rule.

At 340, an extraction accuracy of the subsequent rule may be determined by comparing the attributes of the subsequent data set with the attributes of the first data set or a baseline data set. The extraction accuracy of the subsequent rule indicates the suitability of the subsequent rule for extracting data in place of the first rule. In one embodiment, the accuracy value of subsequent rule for each web page may be determined by matching the subsequent set of attributes of the web page with the first set of attributes of the web page. Based on the accuracy value for each web page in the first cluster, an overall accuracy value of the subsequent rule for the first cluster may be calculated. The accuracy value may vary from 0 to 1. An accuracy value of 1 indicates that a subsequent rule is able to extract data from baseline cluster with the same accuracy as the baseline rule.

At 344, if a threshold for extraction accuracy is met or exceeded, a subsequent rule is approved for data extraction of a baseline cluster. In an embodiment of the invention, the predetermined threshold value is equal to 1. In other embodiments, a less than perfect accuracy can be set as a threshold, depending on a tolerance necessary for use of the extracted data.

At 346, if a threshold for extraction data is not met, a subsequent rule is eliminated for data extraction. The subsequent rule may introduce erroneous data tables, misconstrue, or miss some data altogether.

At 370, duplicates of approved rule are removed. In the present embodiment, rules are reduced on a per cluster basis. Additional details are provided below with respect to FIG. 4.

FIG. 4 is a flow chart illustrating an exemplary method 370 for removing duplicates of approved rules, in accordance with an embodiment.

At step 410, each cluster with multiple approved rules is identified. As described above, each of the approved rules extracts data for the cluster with sufficient accuracy.

At step 420, rules that cover the most amount of clusters with the minimum number of rules is selected. Various algorithms can be run to minimize the number of rules. In one embodiment, a first rule covering a maximum number of clusters is selected. Of the remaining clusters, the process is repeated to select a second rule, and additional rules until all clusters are covered.

At 430, clusters associated with each rule are combined to form super clusters. The reduced number of rules covers the same extraction needs as the original set of rules, but can be processed more efficiently.

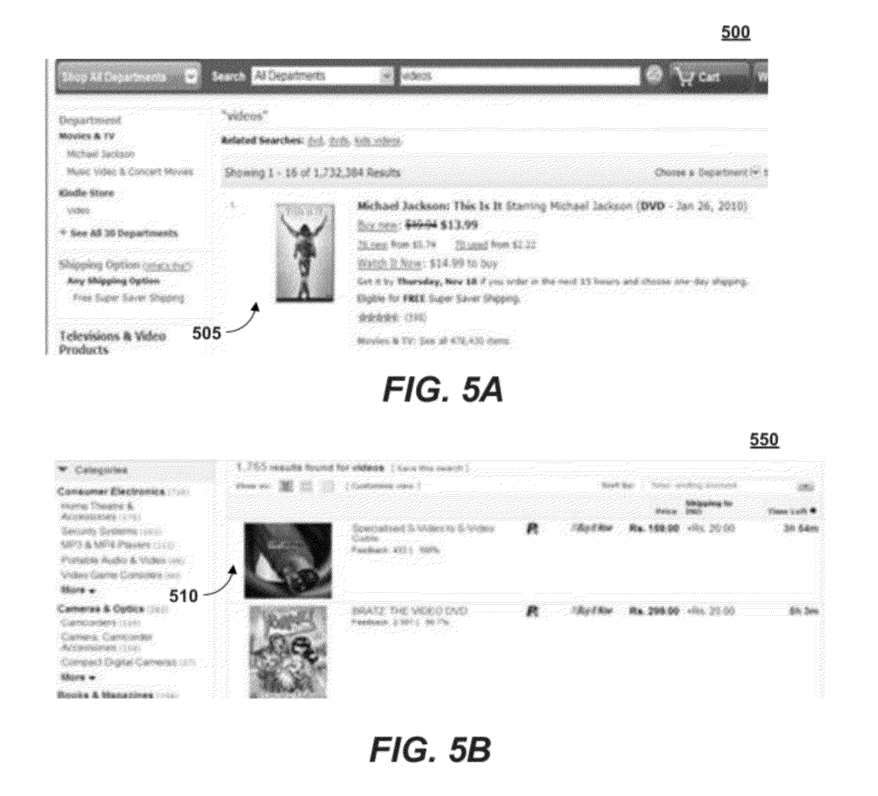

FIGS. 5A-B are schematic diagrams illustrating web pages 500, 550 of different clusters that can be combined for the purpose of data extraction, in accordance with an embodiment. After being retrieved by a web crawler, web page 500 could be classified into a different cluster than web page 550 because of differing page structures. For example, product information of web page 500 is organized into a table with two columns, while product information of web page 500 is organized into seven or more columns. As a result, HTML tags or structure in the corresponding source code will differ.

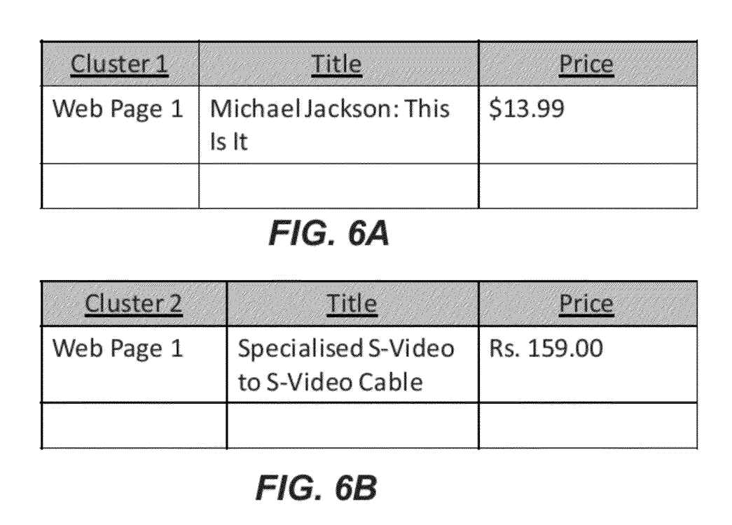

However, if the only data gleaned from these pages are title and price, as shown in FIGS. 6A-B, the difference in page structures may be irrelevant. A common rule searching for a title header and a price header extracts the same data when applied to either of the web pages 500, 550. Under these circumstances, the two clusters can potentially be combined into a super cluster using the methods described herein. On the other hand, if the rule for web page 550 is also configured to extract an amount of time left to bid, that same data is not found on web page 500. Under those circumstances, the two clusters would remain separate, using separate rules for data extraction.

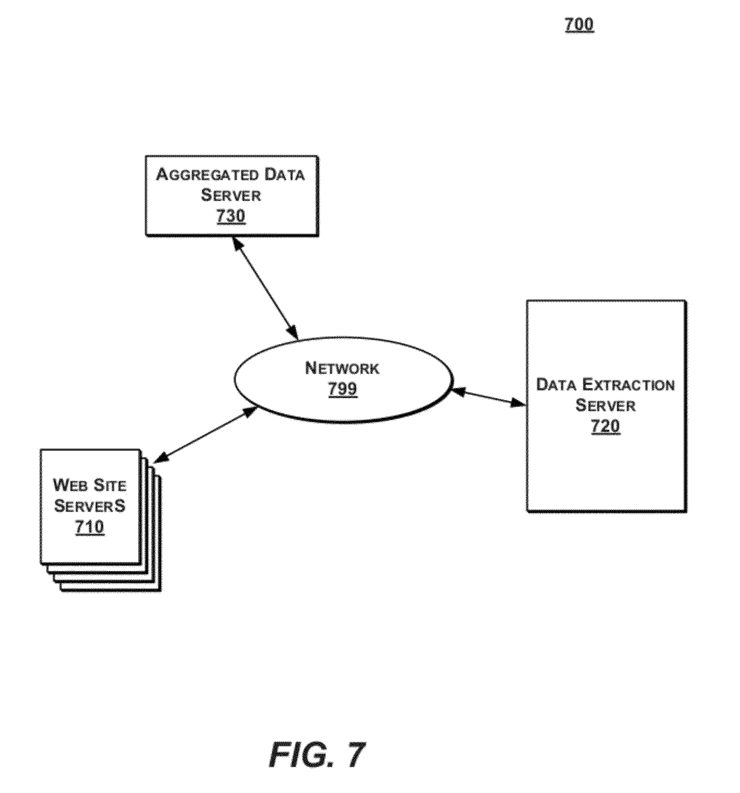

FIG. 7 is a block diagram of a system 700 for data extraction using super clustering, in accordance with an embodiment. The system 700 can implement methods discussed above. The system 600 includes web site servers 710, a data extraction server 720, and an aggregated data server 730, coupled in communication through a network 799 (e.g., the Internet or a cellular network).

The web site servers 710 can be one or more of, for example, a PC (Personal Computer), a laptop, a server blade, or any other processor-based device. The individual web site servers 710 can be related or independent. In one embodiment, the web site servers 710 store web sites and individual web pages. The web site servers 710 can dynamically generate web pages in a formatted structure using information stored on a database.

The data extraction server 720 can be, for example, can be one or more of any of the above processor-based devices. In one embodiment, the data extraction server extracts data from web pages on the web site servers 710 using super clusters. Additional embodiments of the data extraction server 720 are described in more detail below.

The aggregated data server can be one or more of any of the above processor-based devices. In one embodiment, the aggregated data server 730 stores data extracted by the data extraction server 720.

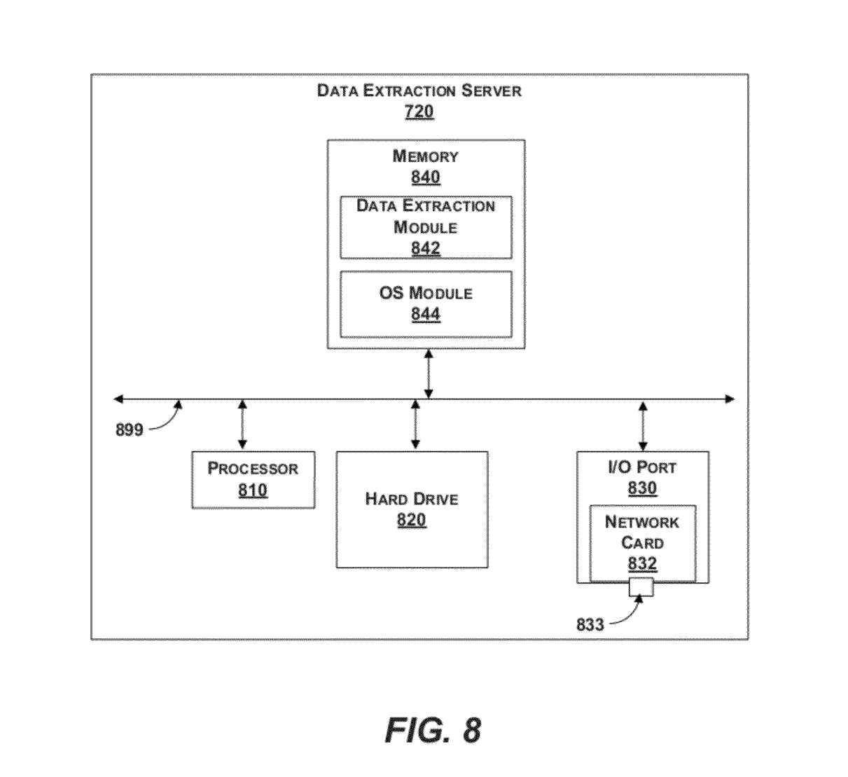

FIG. 8 is a block diagram of an exemplary data extraction server 720, in accordance with an embodiment. The data extraction server 720 includes a processor 810, a hard drive 820, an I/O port 830, and a memory 840 coupled by a bus 899. In one embodiment, the data extraction server 720 is customized for data extraction. In other embodiments, the data extraction server 720 is a general computing device that is also configured to perform other processes.

The bus 899 can be soldered to one or more motherboards. The processor 810 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 810 is specially suited for the processing demands of data extraction (e.g., custom micro-code, instruction fetching, pipelining or cache sizes). The processor 810 can be disposed on silicon or any other suitable material. In operation, the processor 810 can receive and execute instructions and data stored in the memory 840 or the hard drive 820. The hard drive 820 can be a platter-based storage device, a flash drive, an external drive, a persistent memory device, or any other type of memory.

The hard drive 820 provides persistent (i.e., long term) storage for instructions and data. The I/O port 820 is an input/output panel including a network card 832. The network card 832 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 833 is configured according to networking compatibility. For example, a wired networking card includes a physical port to plug in a cord, and a wireless networking card includes an antennae. The network card 833 provides access to a communication channel on a network.

The memory 840 can be a RAM (Random Access Memory), a flash memory, a non-persistent memory device, or any other device capable of storing program instructions being executed. The memory 840 further comprises a data extraction module 842, and an OS (operating system) module 844. The tweet module comprises any type of tweet client or web browser used to send tweets with geotags. The OS module 844 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

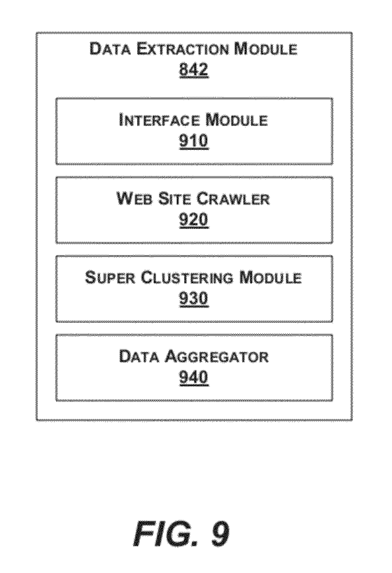

FIG. 9 is a block diagram of a data extraction module 842, in accordance with an embodiment. The data extraction module 842 includes an interface module 910, a web site crawler 920, a super clustering module 930 and a data aggregator 940. These components can communicate through software ports such as APIs (Application Programming Interface).

In one embodiment, the interface module provides a communication channel over a network. The interface module 910 can use Internet protocols such as TCP/IP (Transmission Control Protocol/Internet Protocol), HTTP (HyperText Transmission Protocol), FTP (File Transmission Protocol) and others, over the WWW (World Wide Web) and other networks. The web site crawler 920 can request web pages from a preconfigured list in a systematic manner. The super clustering module 930 can combine clusters of crawled web pages to generate super clusters. The data aggregator 940 extracts data from the web pages using super rules. The data aggregator 940 can further combine extracted data.

The invention as described above has numerous advantages. Based on the aforementioned explanation, it can be concluded that the various embodiments of the present invention may be utilized for data extraction from one or more web pages. The invention provides a method, a system and a computer program product for reducing a set of clusters and corresponding rules that provide the same accuracy as provided by any of the available rules in a set of rules. Further, this results in time efficiency in processing web pages in reduced number of set of clusters and rules. Further, this provides space efficiency by removing a particular rule (from the set of rules) and grouping the corresponding cluster with any of the available clusters. Also, the processing may become efficient for any new page due to reduction in the number of available clusters and rules.

The present invention may also be embodied in a computer program product for data extraction. The computer program product may include a non-transitory computer usable medium having a set program instructions comprising a program code for enabling the system to determine an extraction accuracy of a rule. The set of instructions may include various commands that instruct the processing machine to perform specific tasks such as tasks corresponding to determining the extraction accuracy for reducing the number of clusters in a set of clusters. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A computer-implemented method for data extraction, comprising:
receiving a set of clusters associated with a plurality of crawled web pages, each cluster defined by a subset of the plurality of web pages having a common page structure for data extraction;
extracting a first data set by applying a first rule to web pages of a first cluster of the set of clusters, the first rule corresponding to the first cluster;
applying a second rule to the web pages of the first cluster to extract a second data set, the second rule corresponding to a second cluster of the set of clusters;
determining an extraction accuracy of the second rule by comparing attributes of the second data set to attributes of the first data set; and
setting the second rule for data extraction from the web pages associated with the first cluster responsive to the extraction accuracy meeting a predetermined threshold value.

2. The method of claim 1, wherein the first data set attributes and the second data set attribute comprise data types and data values.

3. The method of claim 1, wherein the page structure of the first cluster differs from a page structure of the second cluster.

4. The method of claim 1, wherein a value of the extraction accuracy ranges from 0 to 1, and the predetermined threshold is set to 1.

5. The method of claim 1, further comprising:
receiving a set of unique rules for data extraction, each of the unique rules associated with a cluster from the set of clusters; and
reducing a number of unique rules in the set of rules by removing unique rules associated with certain clusters covered by the first rule, wherein each of the set of clusters is associated with a unique rule for data extractions.

6. The method of claim 1, further comprising:
receiving a set of unique rules for data extraction, each of the unique rules associated with a cluster from the set of clusters;
responsive to not meeting the predetermined threshold by the extraction accuracy, applying a subsequent rule in the set of the unique rules to the web pages of the first cluster to extract a subsequent data set, the subsequent rule corresponding to a subsequent cluster in the set of clusters;
determining an extraction accuracy of the subsequent rule, the extraction accuracy being determined by comparing attributes of the subsequent data set to the attributes of the first data set; and
setting the subsequent rule for data extraction from web pages associated with the first cluster responsive to the extraction accuracy meeting a predetermined threshold value.

7. The method of claim 1, further comprising:
applying the second rule to the second cluster to extract a third data set,
wherein determining the extraction accuracy also comprises comparing attributes of the third data set to the attributes of the first data set.

8. The method of claim 1, wherein the plurality of web pages are associated with at least one of a common web site or a common subject matter.

9. A computer-implemented method for data extraction, comprising:
receiving a set of clusters associated with a plurality of crawled web pages, each cluster defined by a subset of the plurality of web pages having a common page structure for data extraction, each cluster having an associated rule for extracting data;
reducing a number of rules for extraction by forming super clusters, a super cluster comprising two or more clusters of the set of clusters, each super cluster using a common rule that extracts data with sufficient accuracy from the two or more clusters, the common rule originally being associated with one of the two or more clusters; and
extracting data from the super clusters using associated common rules for storage in a database.

10. A computer program product for use with a computer, the computer program product comprising a non-transitory computer usable medium having a computer readable program code embodied therein for data extraction, the computer readable program code when executed performing a method comprising:
receiving a set of clusters associated with a plurality of crawled web pages, each cluster defined by a subset of the plurality of web pages having a common page structure for data extraction;
extracting a first data set by applying a first rule to web pages of a first cluster of the set of clusters, the first rule corresponding to the first cluster;
applying a second rule to the web pages of the first cluster to extract a second data set, the second rule corresponding to a second cluster of the set of clusters;
determining an extraction accuracy of the second rule by comparing attributes of the second data set to attributes of the first data set; and
setting the second rule for data extraction from the web pages associated with the first cluster responsive to the extraction accuracy meeting a predetermined threshold value.

11. The computer program product of claim 10, wherein the first data set attributes and the second data set attributes comprise data types and data values.

12. The computer program product of claim 10, wherein a page structure of the first cluster differs from a page structure of the second cluster.

13. The computer program product of claim 10, wherein a value of the extraction accuracy ranges from 0 to 1, and the predetermined threshold is set to 1.

14. The computer program product of claim 10, further comprising:
receiving a set of unique rules for data extraction, each of the unique rules associated with a cluster from the set of clusters; and
reducing a number of unique rules in the set of rules by removing unique rules associated with certain clusters covered by the first rule, wherein each of the set of clusters is associated with a unique rule for data extractions.

15. The computer program product of claim 10, further comprising:
receiving a set of unique rules for data extraction, each of the unique rules associated with a cluster from the set of clusters;
responsive to not meeting the predetermined threshold by the extraction accuracy, applying a subsequent rule in the set of the unique rules to the web pages of the first cluster to extract a subsequent data set, the subsequent rule corresponding to a subsequent cluster in the set of clusters;
determining an extraction accuracy of the subsequent rule, the extraction accuracy being determined by comparing attributes of the subsequent data set to the attributes of the first data set; and
setting the subsequent rule for data extraction from web pages associated with the first cluster responsive to the extraction accuracy meeting a predetermined threshold value.

16. The computer program product of claim 10, further comprising:
applying the second rule to the second cluster to extract a third data set,
wherein determining the extraction accuracy also comprises comparing attributes of the third data set to the attributes of the first data set.

17. A system for data extraction, comprising:
a clustering module to receive a set of clusters associated with a plurality of crawled web pages, each cluster defined by a subset of the plurality of web pages having a common page structure for data extraction;
a data extraction module, coupled in communication with the clustering module, the data extraction module extracting a first data set by applying a first rule to web pages of a first cluster of the set of clusters, the first rule corresponding to the first cluster, the data extraction module applying a second rule to the web pages of the first cluster to extract a second data set, the second rule corresponding to a second cluster of the set of clusters; and
a rule selection module, coupled in communication with the data extraction module, the rule selection module determining an extraction accuracy of the second rule by comparing attributes of the second data set to attributes of the first data set, and set the second rule for data extraction from the web pages associated with the first cluster responsive to the extraction accuracy meeting a predetermined threshold value.

18. The system of claim 17, wherein the first data set attributes and the second data set attribute comprise data types and data values.

19. The system of claim 17, wherein the data extraction module receives a set of unique rules for data extraction, each of the unique rules associated with a cluster from the set of clusters, and the rule selection module reduces a number of unique rules in the set of rules by removing unique rules associated with the certain clusters covered by the first rule, wherein each of the set of clusters is associated with a unique rule for data extractions.

20. The system of claim 17, wherein the data selection module is further configured to receive a set of unique rules for data extraction, each of the unique rule associated with a cluster from the set of clusters, and responsive to not meeting the predetermined threshold by the extraction accuracy, apply a subsequent rule in the set of the unique rules to the web pages of the first cluster to extract a subsequent data set, the subsequent rule corresponding to a subsequent cluster in the set of clusters, and the rule selection module is further configured to determine an extraction accuracy of the subsequent rule, the extraction accuracy being determined by comparing attributes of the subsequent data set to the attributes of the first data set, and set the subsequent rule for data extraction from web pages associated with the first cluster responsive to the extraction accuracy meeting a predetermined threshold value.
